(19) United States
(12) Patent Application Publication
(10) Pub. No.: US 2021/0067091 A1
(43) Pub. Date: Mar. 4, 2021

(54) SERVER

(71) Applicant: LG ELECTRONICS INC., Seoul (KR)

(72) Inventors: Mookang SONG, Seoul (KR); Bongsu Cho, Seoul (KR); Hyeojun Moon, Seoul (KR)

(73) Assignee: LG ELECTRONICS INC., Seoul (KR)

(21) Appl. No.: 17/003,791

(22) Filed: Aug. 26, 2020

(30) Foreign Application Priority Data
Aug. 30, 2019 (KR) 10-2019-0107746

(51) Int. Cl. H02S 50/00; G01W 1/00; G06N 7/00; G06N 20/00

(52) U.S. Cl. CPC H02S 50/00; G06N 20/00; G06N 7/005; G01W 1/00

(57) ABSTRACT

Provided is a server including a communicator to receive data from an external network or to transmit data to the external network and a processor to receive power generation information of a solar module and weather information through the communicator and to predict a power generation amount of the solar module based on the power generation information of the solar cell module and the weather information, wherein the processor predicts the power generation amount of the solar module by adding time information to a prediction model.

### CROSS-REFERENCE TO RELATED APPLICATION

Pursuant to 35 U.S.C. § 119(a), this application claims the benefit of earlier filing date and right of priority to Korean Patent Application No. 10-2019-0107746, filed on Aug. 30, 2019, the contents of which are hereby incorporated by reference herein in its entirety.

### BACKGROUND OF THE DISCLOSURE

### 1. Field of the Disclosure

The present disclosure relates to a server, and more particularly, to a server capable of accurately predicting a power generation amount of a solar module.

### 2. Description of the Related Art

A power generation amount of solar modules varies depending on weather information or the like.

Accordingly, research has been conducted to predict a power generation amount based on weather information and the like.

In particular, research into prediction of a photovoltaic power generation amount when future weather forecast data is given by mathematically modeling an influence of weather data on the power generation amount of a solar module has been conducted but there is a problem in that a lot of errors occur in the prediction of the current power generation.

### SUMMARY OF THE DISCLOSURE

The present disclosure provides a server capable of accurately predicting a power generation amount of a solar module.

In an aspect, a server includes: a communicator to receive data from an external network or to transmit data to the external network; and a processor to receive power generation information of a solar module and weather information through the communicator and to predict a power generation amount of the solar module based on the power generation information of the solar cell module and the weather information, wherein the processor predicts the power generation amount of the solar module by adding time information to a prediction model.

Meanwhile, the processor may perform learning based on the prediction model and predict the power generation amount of the solar module as a result of the learning.

Meanwhile, the processor may update the prediction model.

Meanwhile, the processor may predict the power generation amount of the solar module during a first period.

Meanwhile, the processor may control the first period to increase as accuracy of the weather information increases.

Meanwhile, the prediction model may include a Gaussian process.

Meanwhile, the processor may predict the power generation amount of the solar module by adding time information to the Gaussian process.

Meanwhile, the server may further include a memory to store power generation amount prediction information of the solar module.

Meanwhile, the processor may control to generate and output abnormality information of the solar module if a difference between the power generation amount prediction information of the solar module and an actual power generation amount of the solar module is greater than or equal to a predetermined value.

Meanwhile, the processor may predict a power generation amount for each of a plurality of solar modules and control to perform balancing of power generation amounts of the plurality of solar modules based on a plurality of power generation amount prediction information.

Meanwhile, the processor may predict a power generation amount for each of the plurality of solar modules, and if a difference between power generation amount prediction information of a first solar module and power generation amount prediction information of a second solar module, among the plurality of solar modules, is equal to or greater than a reference value, the processor may output a control signal for lowering a power generation amount of the second solar module predicted to have a greater power generation amount.

Meanwhile, the processor may control to output power generation amount prediction information of the solar module.

Meanwhile, the processor may generate power generation amount prediction information of a plurality of solar modules through a plurality of prediction models and predict a power generation amount of the solar module based on a first prediction model which is least different from an actual power generation amount among the plurality of prediction models during a predetermined period.

Meanwhile, if power generation amount prediction information of a second prediction model is least different from the actual power generation amount compared with the first prediction model, the processor may change a prediction model from the first prediction model to the second prediction model and predict a power generation amount of the solar module based on the second prediction model.

Meanwhile, the processor may update the plurality of prediction models.

In another aspect, a server includes: a communicator to receive data from an external network or to transmit data to the external network; and a processor to receive power generation information of a solar module and weather information through the communicator and to predict a power generation amount of the solar module based on the power generation information of the solar cell module and the weather information, wherein the processor predicts the power generation amount of the solar module based on a Gaussian process.

Meanwhile, the processor may perform learning based on the Gaussian process and predict a power generation amount of the solar module as a result of the learning.

Meanwhile, the server may further include a memory to store power generation amount prediction information of the solar module.

Meanwhile, the processor may control to generate and output abnormality information of the solar module if a difference between the power generation amount prediction information of the solar module and an actual power generation amount of the solar module is greater than or equal to a predetermined value.

Meanwhile, the processor may predict a power generation amount for each of a plurality of solar modules and control to perform balancing of power generation amounts of the plurality of solar modules based on a plurality of power generation amount prediction information.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1A is a view illustrating an example of a solar system including a solar module according to an embodiment of the present disclosure;

FIG. 1B is a view illustrating another example of a solar system including a solar module according to an embodiment of the present disclosure;

FIG. 1C is a view illustrating an example of a solar system including a solar module according to another embodiment of the present disclosure;

FIG. 2 is a simplified internal block diagram of a server of FIG. 1;

FIG. 3 is an example of an internal block diagram of a processor of FIG. 2; and

FIGS. 4 to 7B are views referred to for illustrating an operation of the processor of FIG. 3.

### DETAILED DESCRIPTION OF THE PREFERRED EMBODIMENTS

Hereinafter, the present disclosure will be described in more detail with reference to the drawings.

In the following description, usage of suffixes such as ‘module’, ‘part’ or ‘unit’ used for referring to elements is given merely to facilitate explanation of the present invention, without having any significant meaning by itself. Therefore, the ‘module’ or ‘part’ or ‘unit’ may be used in combination.

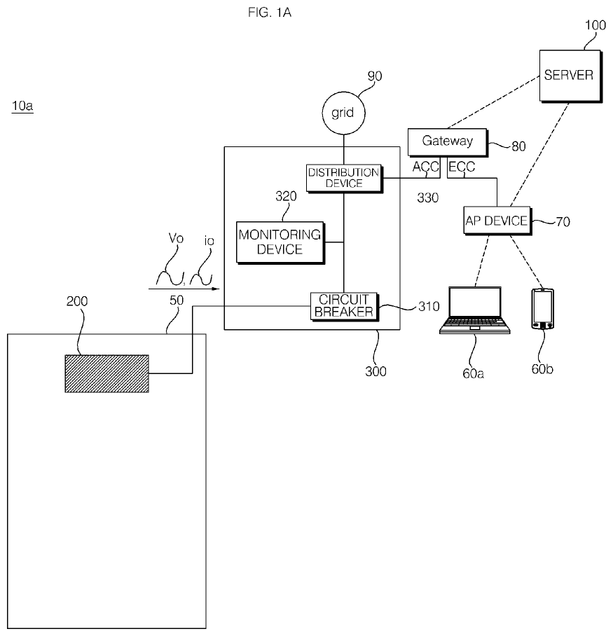

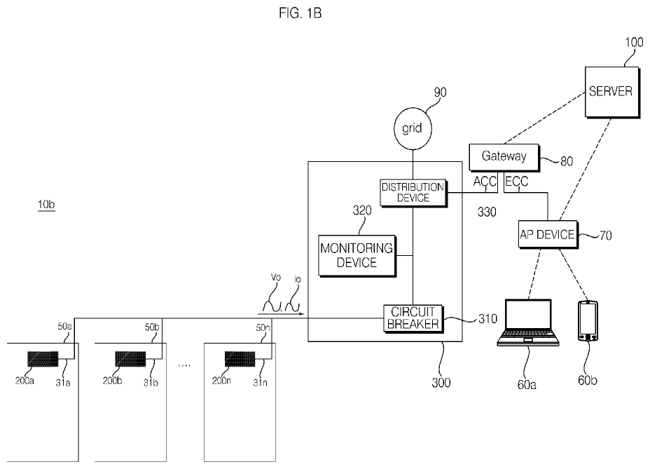

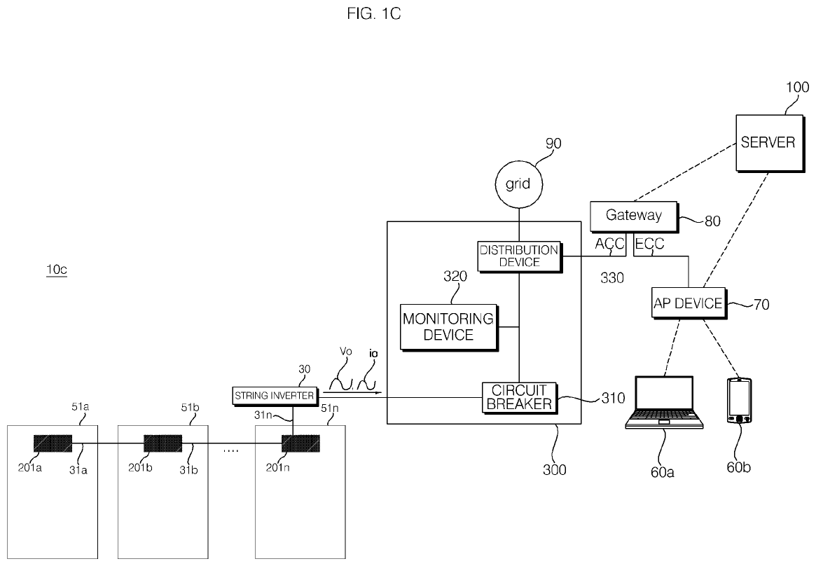

FIG. 1A is a view illustrating an example of a solar system including a solar module according to an embodiment of the present disclosure.

Referring to FIG. 1, a solar system 10a according to an embodiment of the present disclosure may include a solar module 50, a power distribution device 300, a gateway 80, an AP device 70, a server 100, and the like.

The solar module 50 may include a solar cell module (not shown) and a junction box 200 including a power conversion device (not shown) that converts DC power from the solar cell module and outputs the converted power.

In the drawing, the junction box 200 is illustrated to be attached to a rear surface of the solar cell module, but is not limited thereto. The junction box 200 may be provided separately and spaced apart from the solar cell module.

Meanwhile, the AC power output from the junction box 200 is supplied to the power distribution device 300.

The power distribution device 300 may receive AC power from the solar module 50 and may also receive AC power from an external grid 90.

Also, the power distribution device 300 may supply AC power to an internal power grid of a building using AC power from the solar module 50 and AC power from the external grid 90.

In the drawing, it is illustrated that an AC power cable (ACC) is disposed in a power grid inside the building and a gateway 80 is electrically connected to the AC power cable (ACC).

Meanwhile, although not shown, an electric device (not shown) or the like may be connected to an AC power cable (ACC), which is a power grid inside the building, and may consume AC power therein.

The AP device 70 provides a wired or wireless network to various electric devices in the building. Meanwhile, the AP device 70 may be connected to the external server 100 through an external network.

In the drawing, it is illustrated that a terminal such as a notebook computer 60a or a mobile terminal 60b is wirelessly connected to the AP device 70.

Meanwhile, the external server 100 may be remotely connected to the gateway 80 or the AP device 70 through an external network.

Meanwhile, the gateway 80 and the AP device 70 may be electrically connected through a network cable (ECC).

Meanwhile, the power distribution device 300 may include a monitoring device 320 detecting current information of AC power input from the solar module 50 and transmitting detected AC current information to the external gateway 80 through power line communication (PLC).

Meanwhile, the power distribution device 300 may further include a circuit breaker 310 for cutting off the AC power input from the solar module 50 and a distribution device 330 distributing AC power input from the solar module 50 and AC power input from the external grid 90 and supplying the AC power to the internal power grid of the building.

Meanwhile, the gateway 80 may receive power generation information of the solar module 50 based on the AC current detection information from the solar module 50.

Meanwhile, the server 100 may access the gateway 80 or the AP device 70 by wire or wirelessly to receive data or transmit data.

Meanwhile, the server 100 may receive power generation information of the solar module 50 from the gateway 80 or the AP device 70.

Meanwhile, the server 100 may predict a power generation amount of the solar module 50 based on the power generation information of the solar module 50 and weather information.

In particular, in order to accurately predict a power generation amount of the solar module 50, the server 100 according to an embodiment of the present disclosure predicts a power generation amount of the solar module 50 by adding time information to a prediction model. Accordingly, the power generation amount of the solar module 50 may be accurately predicted.

Meanwhile, the server 100 may perform learning based on the prediction model and predict a power generation amount of the solar module 50 as a result of the learning. Accordingly, the power generation amount of the solar module 50 may be accurately predicted.

Meanwhile, the server 100 may update the prediction model. Accordingly, the power generation amount of the solar module 50 may be accurately predicted.

Meanwhile, the server 100 may predict a power generation amount of the solar module 50 during a first period.

Accordingly, the power generation amount of the solar module 50 may be accurately predicted.

Meanwhile, the server 100 may control the first period to increase as accuracy of the weather information increases. Accordingly, a power generation amount prediction period of the solar module 50 may be increased.

Meanwhile, the prediction model may include a Gaussian process. Accordingly, the power generation amount of the solar module 50 may be accurately predicted.

Meanwhile, the server 100 may predict the power generation amount of the solar module 50 by adding time information to the Gaussian server 100. Accordingly, the power generation amount of the solar module 50 may be accurately predicted.

Meanwhile, the server 100 according to an embodiment of the present disclosure may further include a memory 140 for storing power generation amount prediction information of the solar module 50. Accordingly, it may be compared with an actual power generation amount.

Meanwhile, when a difference between the power generation amount prediction information of the solar module 50 and an actual power generation amount of the solar module 50 is greater than or equal to a predetermined value, the server 100 may control to generate and output abnormality information of the solar module 50. Accordingly, whether the solar module 50 is abnormal may be checked.

Meanwhile, the server 100 may control to output power generation amount prediction information of the solar module 50. Accordingly, load balancing of a load connected to the solar module 50 may be performed.

Meanwhile, the server 100 may generate power generation amount prediction information of the solar module 50 through a plurality of prediction models and predict a power generation amount of the solar module 500 based on a first prediction model which is least different from the actual power generation among a plurality of prediction models amount during a predetermined period. Accordingly, the power generation amount of the solar module 50 may be accurately predicted.

Meanwhile, if power generation amount prediction information of a second prediction model is least different from the actual power generation amount compared with the first prediction model, the server 100 may change a prediction mode from the first prediction model to the second prediction model and predict a power generation amount of the solar module 50 based on the second prediction model. Accordingly, the power generation amount of the solar module 50 may be accurately predicted.

Meanwhile, the server 100 may update a plurality of prediction models. Accordingly, the power generation amount of the solar module 50 may be accurately predicted.

Meanwhile, the server 100 according to another embodiment of the present disclosure predicts a power generation amount of the solar module 50 based on power generation information of the solar module 50 and weather information, and in particular, the server 100 predicts a power generation amount of the solar module 50 based on the Gaussian server 100. Accordingly, the power generation amount of the solar module 50 may be accurately predicted.

Meanwhile, the server 100 may perform learning based on the Gaussian server 100 and predict the power generation amount of the solar module 50 as a result of the learning. Accordingly, the power generation amount of the solar module 50 may be accurately predicted.

Meanwhile, the server 100 according to another embodiment of the present disclosure further includes a memory 140 for storing power generation amount prediction information of the solar module 50. Accordingly, it may be compared with an actual power generation amount.

Meanwhile, if a difference between the power generation amount prediction information of the solar module 50 and an actual power generation amount of the solar module 50 is greater than or equal to a predetermined value, the server 100 may control to generate and output abnormality information of the solar module 50. Accordingly, whether the solar module 50 is abnormal may be checked.

Meanwhile, the server 100 may predict a power generation amount for each of a plurality of solar modules 50a to 50n and may control to perform balancing of power generation amounts of the plurality of solar modules 50a to 50n. Accordingly, balancing of the power generation amounts in the plurality of solar modules 50a to 50n may be performed.

FIG. 1B is a view illustrating another example of a solar system including a solar module according to an embodiment of the present disclosure.

Referring to the drawing, a solar system 10b according to an embodiment of the present disclosure may include a plurality of solar modules 50a to 50n, a power distribution device 300, a gateway 80, and an AP device 70, a server 100, and the like.

The solar system 10b of FIG. 1b is different from the solar system 10a of FIG. 1a in that a plurality of solar modules 50a, 50b, . . . , 50n are connected in parallel to each other.

The plurality of solar modules 50a, 50b, . . . , 50n may include solar cell modules and junction boxes 200a, 200b, . . . , 200n including circuit elements for converting DC power from the solar cell modules and outputting converted power, respectively.

In the drawing, it is illustrated that each junction box 200a, 200b, . . . , 200n is attached to a rear surface of each solar cell module, but is not limited thereto. Each junction box 200a, 200b, . . . , 200n may be provided separately and spaced apart from each solar cell module.

Meanwhile, cables 31a, 31b, . . . , 31n for outputting the AC power output from the junction boxes 200a, 200b, . . . , 200n may be electrically connected to output terminals of the junction boxes 200a, 200b, . . . , 200n, respectively.

Meanwhile, the AC power output from the junction boxes 200a, 200b, . . . , 200n is supplied to the power distribution device 300.

The power distribution device 300 may receive AC power from a plurality of solar modules 50a to 50n and may also receive AC power from the external grid 90.

In addition, the power distribution device 300 may supply AC power to an internal power grid of a building using AC power from a plurality of solar modules 50a to 50n and AC power from the external grid 90.

In the drawing, it is illustrated that an AC power cable (ACC) is disposed in a power grid inside the building and a gateway 80 is electrically connected to the AC power cable (ACC).

Meanwhile, although not shown, an electric device (not shown) or the like may be connected to an AC power cable (ACC), which is a power grid inside the building, and may consume AC power therein.

The AP device 70 provides a wired or wireless network to various electric devices in the building. Meanwhile, the AP device 70 may be connected to the external server 100 through an external network.

In the drawing, it is illustrated that a terminal such as a notebook computer 60a or a mobile terminal 60b is wirelessly connected to the AP device 70.

Meanwhile, the external server 100 may be remotely connected to the gateway 80 or the AP device 70 through an external network.

Meanwhile, the gateway 80 and the AP device 70 may be electrically connected through a network cable (ECC).

Meanwhile, the power distribution device 300 may include a monitoring device 320 detecting current information of AC power input from the plurality of solar modules 50a to 50n and transmitting detected AC current information to the external gateway 80 through power line communication (PLC).

Meanwhile, the power distribution device 300 may further include a circuit breaker 310 for cutting off the AC power input from the plurality of solar modules 50a to 50n and a distribution device 330 distributing AC power input from the plurality of solar modules 50a to 50n and AC power input from the external grid 90 and supplying the AC power to the internal power grid of the building.

Meanwhile, the gateway 80 may receive power generation information of the plurality of solar modules 50a to 50n based on AC current detection information from the plurality of solar modules 50a to 50n.

Meanwhile, the server 100 may access the gateway 80 or the AP device 70 by wire or wirelessly to receive data or transmit data.

Meanwhile, the server 100 may receive power generation information of the plurality of solar modules 50a to 50n from the gateway 80 or the AP device 70.

Meanwhile, the server 100 may predict power generation amount of the plurality of solar modules 50a to 50n based on the power generation information of the plurality of solar modules 50a to 50n and weather information.

In particular, in order to accurately predict a power generation amount of the plurality of solar modules 50a to 50n, the server 100 according to an embodiment of the present disclosure predicts a power generation amount of the plurality of solar modules 50a to 50n by adding time information to a prediction model. Accordingly, the power generation amount of the solar module 50 may be accurately predicted.

Meanwhile, the server 100 may perform the operation illustrated in FIG. 1A as it is.

Meanwhile, the server 100 may predict a power generation amount for each of the plurality of solar modules 50a to 50n, and may control to perform balancing of power generation amounts of the plurality of solar modules 50a to 50n based on the plurality of power generation amount prediction information. Accordingly, balancing of the power generation amounts in the plurality of solar modules 50a to 50n may be performed.

Meanwhile, the server 100 may predict a power generation amount for each of the plurality of solar modules 50a to 50n, and if a difference between the power generation amount prediction information of a first solar module 50a, among the plurality of solar modules 50a to 50n, and prediction information of a second solar module 50b is equal to or greater than a reference value, the server 100 may output a control signal for lowering a power generation amount of the second solar module 50 predicted to have a greater power generation amount. Accordingly, balancing of power generation amounts in the plurality of solar modules 50a to 50n may be performed.

FIG. 1C is a view illustrating an example of a solar system including a solar module according to another embodiment of the present disclosure.

Referring to the drawing, a solar system 10c according to an embodiment of the present disclosure may include a plurality of solar modules 51a to 51n, a string inverter connected to the plurality of solar modules 51a to 51n, a distribution device 300, a gateway 80, an AP device 70, a server 100, and the like.

The solar system 10c of FIG. 1C is different from the solar system 10a of FIG. 1b in that a plurality of solar modules 51a, 51b, . . . , 51n connected in series with each other output DC power and a string inverter 30 is connected to each of output terminals of the plurality of solar modules 51a, 51b, . . . , 51n.

The plurality of solar modules 51a, 51b, . . . , 51n may include solar cell modules and junction boxes 201a, 201b, . . . , 201n including circuit elements for converting DC power from the solar cell modules and outputting converted power.

In the drawing, it is illustrated that the junction boxes 201a, 201b, . . . , 201n are attached to rear surfaces of the solar cell modules, but is not limited thereto. Each of the junction boxes 201a, 201b, . . . , 201n may be separately provided and spaced apart from each solar cell module.

Meanwhile, cables 31a, 31b, . . . , 31n for outputting DC power output from the junction boxes 201a, 201b, . . . , 201n may be electrically connected to output terminals of the junction boxes 201a, 201b, . . . , 201n, respectively.

Meanwhile, the DC power output from each of the junction boxes 201a, 201b, . . . , 201n is supplied to the string inverter 30.

The string inverter 30 converts DC power output from the plurality of solar modules 51a, 51b, . . . , 51n into AC power and supplies the converted AC power to the power distribution device 300.

The power distribution device 300 may receive AC power from the string inverter 30 and may also receive AC power from the external grid 90.

Also, the power distribution device 300 may supply AC power to the internal power grid of the building using AC power from the string inverter 30 and AC power from the external grid 90.

In the drawing, it is illustrated that an AC power cable (ACC) is disposed in a power grid inside the building and a gateway 80 is electrically connected to the AC power cable (ACC).

Meanwhile, although not shown, an electric device (not shown) or the like may be connected to an AC power cable (ACC), which is a power grid inside the building, and may consume AC power therein.

The AP device 70 provides a wired or wireless network to various electric devices in the building. Meanwhile, the AP device 70 may be connected to the external server 100 through an external network.

In the drawing, it is illustrated that a terminal such as a notebook computer 60a or a mobile terminal 60b is wirelessly connected to the AP device 70.

Meanwhile, the external server 100 may be remotely connected to the gateway 80 or the AP device 70 through an external network.

Meanwhile, the gateway 80 and the AP device 70 may be electrically connected through a network cable (ECC).

Meanwhile, the power distribution device 300 may include a monitoring device 320 detecting current information of AC power input from an external string inverter 30 and transmitting detected AC current information to the external gateway 80 through power line communication (PLC).

Meanwhile, the power distribution device 300 may further include a circuit breaker 310 for cutting off the AC power input from the external string inverter 30 and a distribution device 330 distributing AC power input from the external string inverter 30 and AC power input from the external grid 90 and supplying the AC power to the internal power grid of the building.

Meanwhile, the gateway 80 may receive power generation information of the plurality of solar modules 51a to 51n based on the AC current detection information from the plurality of solar modules 51a to 51n.

Meanwhile, the server 100 may access the gateway 80 or the AP device 70 by wire or wirelessly to receive data or transmit data.

Meanwhile, the server 100 may receive power generation information of the plurality of solar modules 51a to 51n from the gateway 80 or the AP device 70.

Meanwhile, the server 100 may predict a power generation amount of the plurality of solar modules 51a to 51n based on the power generation information of the plurality of solar modules 51a to 51n and weather information.

In particular, in order to accurately predict a power generation amount of the plurality of solar modules 51a to 51n, the server 100 according to an embodiment of the present disclosure predicts a power generation amount of the plurality of solar modules 51a to 51n by adding time information to a prediction model. Accordingly, a power generation amount of the solar module 51 may be accurately predicted.

Meanwhile, the server 100 may perform the operation illustrated in FIG. 1A as it is.

Meanwhile, the server 100 may predict a power generation amount for each of the plurality of solar modules 51a to 51n, and may control to perform balancing of power generation amounts of the plurality of solar modules 51a to 51n based on the plurality of power generation amount prediction information. Accordingly, balancing of the power generation amounts in the plurality of solar modules 51a to 51n may be performed.

Meanwhile, the server 100 may predict a power generation amount for each of the plurality of solar modules 51a to 51n, and if a difference between the power generation amount prediction information of a first solar module 51a, among the plurality of solar modules 51a to 51n, and prediction information of a second solar module 51b is equal to or greater than a reference value, the server 100 may output a control signal for lowering a power generation amount of the second solar module 51b predicted to have a greater power generation amount. Accordingly, balancing of power generation amounts in the plurality of solar modules 51a to 51n may be performed.

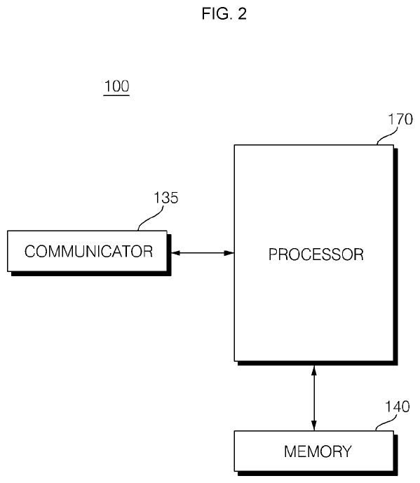

FIG. 2 is a simplified internal block diagram of the server of FIG. 1.

Referring to the drawing, the server 100 may include a communicator 135, a processor 170, and a memory 140.

The communicator 135 may receive data from the external gateway 80 or the AP device 70 or transmit data.

For example, the communicator 135 may receive power generation information of the solar module 50 of FIG. 1A through the communicator 135.

As another example, the communicator 135 may receive power generation information of the plurality of solar modules 50a to 50n of FIG. 1B through the communicator 135.

As another example, the communicator 135 may receive power generation information of the plurality of solar modules 51a to 51n of FIG. 1C through the communicator 135.

The memory 140 may store data necessary for the operation of the server 100.

For example, the memory 140 may store at least one prediction model to be performed in the server 100. The prediction model here may include at least one of a general linear model (GLM), an artificial neural network (ANN) based on a deep neural network, and a Gaussian process (GP).

Meanwhile, the memory 140 may store power generation amount prediction information of the solar module 50. Accordingly, it may be compared with an actual power generation amount.

Meanwhile, the processor 170 may perform an overall operation control of the server 100.

Meanwhile, the processor 170 may predict a power generation amount of the solar module 50 based on the power generation information, weather information, time information and the prediction model of the solar module 50.

Accordingly, the power generation amount of the solar module 50 may be accurately predicted.

Meanwhile, the processor 170 may perform learning based on the prediction model and predict a power generation amount of the solar module 50 as a result of the learning. Accordingly, the power generation amount of the solar module 50 may be accurately predicted.

Meanwhile, the processor 170 may update the prediction model. Accordingly, the power generation amount of the solar module 50 may be accurately predicted.

Meanwhile, the processor 170 may predict a power generation amount of the solar module 50 during a first period. Accordingly, the power generation amount of the solar module 50 may be accurately predicted.

Meanwhile, the processor 170 may control the first period to increase as the accuracy of weather information increases. Accordingly, a power generation amount prediction period of the solar module 50 may be increased.

Meanwhile, the prediction model may include a Gaussian process. Accordingly, a power generation amount of the solar module 50 may be accurately performed.

Meanwhile, the processor 170 may predict a power generation amount of the solar module 50 by adding time information to the Gaussian process. Accordingly, a power generation amount of the solar module 50 may be accurately performed.

Meanwhile, if a difference between the power generation amount prediction information of the solar module 50 and the power generation amount of the actual solar module 50 is greater than or equal to a predetermined value, the processor 170 may control to generate and output abnormality information of the solar module 50. Accordingly, whether the solar module 50 is abnormal may be checked.

Meanwhile, the processor 170 may predict a power generation amount for each of a plurality of solar modules 50a to 50n and may control to perform balancing of power generation amounts of the plurality of solar modules 50a to 50n. Accordingly, balancing of the power generation amounts in the plurality of solar modules 50a to 50n may be performed.

Meanwhile, the processor 170 may predict a power generation amount for each of the plurality of solar modules 50a to 50n, and if a difference between the power generation amount prediction information of a first solar module 50a, among the plurality of solar modules 50a to 50n, and prediction information of a second solar module 50b is equal to or greater than a reference value, the processor 170 may output a control signal for lowering a power generation amount of the second solar module 50 predicted to have a greater power generation amount. Accordingly, balancing of power generation amounts in the plurality of solar modules 50a to 50n may be performed.

Meanwhile, the processor 170 may control to output power generation amount prediction information of the solar module 50. Accordingly, load balancing of a load connected to the solar module 50 may be performed.

Meanwhile, if power generation amount prediction information of a second prediction model is least different from the actual power generation amount compared with the first prediction model, the processor 170 may change a prediction mode from the first prediction model to the second prediction model and predict a power generation amount of the solar module 50 based on the second prediction model. Accordingly, the power generation amount of the solar module 50 may be accurately predicted.

Meanwhile, if power generation amount prediction information of a second prediction model is least different from the actual power generation amount compared with the first prediction model, the processor 170 may change a prediction mode from the first prediction model to the second prediction model and predict a power generation amount of the solar module 50 based on the second prediction model. Accordingly, the power generation amount of the solar module 50 may be accurately predicted.

Meanwhile, the processor 170 may update a plurality of prediction models. Accordingly, the power generation amount of the solar module 50 may be accurately predicted.

Meanwhile, the processor 170 may predict the power generation amount of the solar module 50 based on a Gaussian process. Accordingly, the power generation amount of the solar module 50 may be accurately predicted.

Meanwhile, the processor 170 may perform learning based on the Gaussian process and predict a power generation amount of the solar module 50 as a result of the learning.

Accordingly, the power generation amount of the solar module 50 may be accurately predicted.

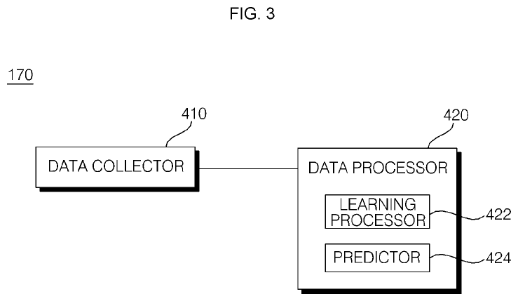

FIG. 3 is an example of an internal block diagram of the processor of FIG. 2.

Referring to the drawing, the processor 170 may include a data collector 410 and a data processor 420.

The data processor 420 may include a learning processor 422 and a predictor 424.

For example, the data collector 410 may collect power generation information of the solar module 50 of FIG. 1A through the communicator 135.

As another example, the data collector 410 may collect power generation information of the plurality of solar modules 50a to 50n of FIG. 1B through the communicator 135.

As another example, the data collector 410 may collect power generation information of the plurality of solar modules 51a to 51n of FIG. 1C through the communicator 135.

Meanwhile, the data processor 420 may predict a power generation amount of the solar module 50 based on the power generation information of the solar module 50, weather information, time information, and a prediction model.

Accordingly, the power generation amount of the solar module 50 may be accurately predicted.

Meanwhile, the learning processor 422 of the data processor 420 may perform learning based on a prediction model, and the predictor 424 of the data processor 420 may predict a power generation amount of the solar module 50 as a result of the learning. Accordingly, the power generation amount of the solar module 50 may be accurately predicted.

Meanwhile, the data processor 420 may update the prediction model. Accordingly, the power generation amount of the solar module 50 may be accurately predicted.

Meanwhile, the data processor 420 may predict a power generation amount of the solar module 50 during a first period. Accordingly, the power generation amount of the solar module 50 may be accurately predicted.

Meanwhile, the data processor 420 may control the first period to increase as accuracy of the weather information increases. Accordingly, a power generation amount prediction period of the solar module 50 may be increased.

Meanwhile, the prediction model may include a Gaussian process. Accordingly, the power generation amount of the solar module 50 may be accurately predicted.

Meanwhile, the data processor 420 may predict the power generation amount of the solar module 50 by adding time information to the Gaussian process. Accordingly, the power generation amount of the solar module 50 may be accurately predicted.

Meanwhile, when a difference between the power generation amount prediction information of the solar module 50 and an actual power generation amount of the solar module 50 is greater than or equal to a predetermined value, the data processor 420 may control to generate and output abnormality information of the solar module 50. Accordingly, whether the solar module 50 is abnormal may be checked.

Meanwhile, the data processor 420 may predict a power generation amount for each of a plurality of solar modules 50a to 50n and may control to perform balancing of power generation amounts of the plurality of solar modules 50a to 50n. Accordingly, balancing of the power generation amounts in the plurality of solar modules 50a to 50n may be performed.

Meanwhile, the data processor 420 may predict a power generation amount for each of the plurality of solar modules 50a to 50n, and if a difference between the power generation amount prediction information of a first solar module 50a, among the plurality of solar modules 50a to 50n, and prediction information of a second solar module 50b is equal to or greater than a reference value, the server 100 may output a control signal for lowering a power generation amount of the second solar module 50 predicted to have a greater power generation amount. Accordingly, balancing of power generation amounts in the plurality of solar modules 50a to 50n may be performed.

Meanwhile, the data processor 420 may control to output power generation amount prediction information of the solar module 50. Accordingly, load balancing of a load connected to the solar module 50 may be performed.

Meanwhile, the data processor 420 may generate power generation amount prediction information of the solar module 50 through a plurality of prediction models and predict a power generation amount of the solar module 500 based on a first prediction model which is least different from the actual power generation among a plurality of prediction models amount during a predetermined period. Accordingly, the power generation amount of the solar module 50 may be accurately predicted.

Meanwhile, if power generation amount prediction information of a second prediction model is least different from the actual power generation amount compared with the first prediction model, the data processor 420 may change a prediction mode from the first prediction model to the second prediction model and predict a power generation amount of the solar module 50 based on the second prediction model. Accordingly, the power generation amount of the solar module 50 may be accurately predicted.

Meanwhile, the data processor 420 may update a plurality of prediction models. Accordingly, the power generation amount of the solar module 50 may be accurately predicted.

Meanwhile, the data processor 420 may predict a power generation amount of the solar module 50 based on a Gaussian process. Accordingly, the power generation amount of the solar module 50 may be accurately predicted.

Meanwhile, the data processor 420 may perform learning based on a Gaussian process and predict a power generation amount of the solar module 50 as a result of the learning. Accordingly, the power generation amount of the solar module 50 may be accurately predicted.

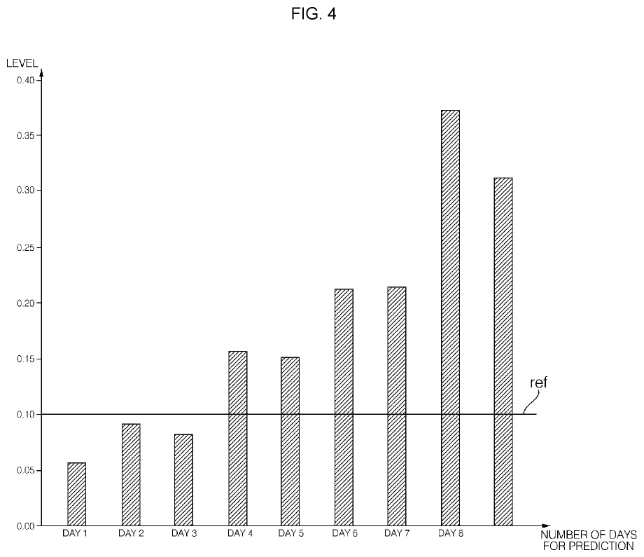

FIGS. 4 to 7B are diagrams referred to for describing an operation of the processor of FIG. 3.

First, FIG. 4 illustrates a graph predicting a power generation amount of a solar module from day 1 to day 9.

Referring to an error reference value (ref), which is a difference between a predicted power generation amount and an actual power generation amount of the solar module, it can be seen that, from day 1 to day 3, differences between the predicted power generation amount and the actual power generation amount of the solar module is lower than the error reference value (ref) and thus prediction is accurately performed.

Meanwhile, it can be seen that, from day 4 to day 9, differences between the predicted power generation amount and the actual power generation amount of the solar module significantly exceeds the error reference value (ref), and thus prediction is inaccurately performed.

The reason why the errors from day 4 to day 9 significantly exceed the error reference value ref is due to inaccuracy in weather information, in particular, weather forecast information.

Accordingly, the server 100 according to an embodiment of the present disclosure predicts a power generation amount of the solar module 50 by adding time information to a prediction model.

In particular, the time information may be a concept including period information for prediction.

That is, the server 100 according to an embodiment of the present disclosure may predict the power generation amount of the solar module 50 during a first period using the prediction model.

Here, the first period may be approximately 3 days or less.

Meanwhile, when the accuracy of the weather forecast information is improved, it is preferable that the first period increases.

That is, the processor 170 may control the first period to increase as the accuracy of weather information increases. Accordingly, the power generation amount prediction period of the solar module 50 may be increased.

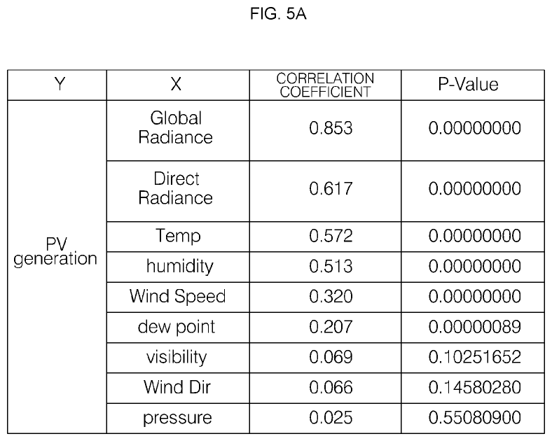

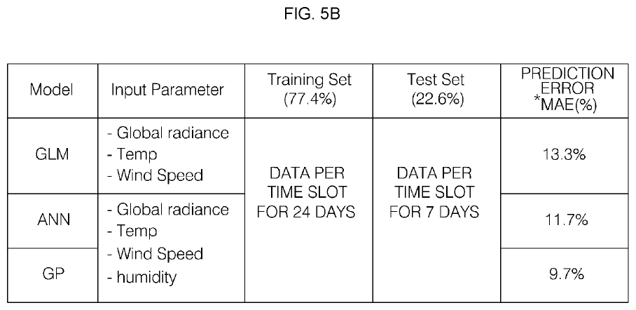

Meanwhile, FIG. 5A is a diagram showing a relationship between weather information and a photovoltaic power generation amount.

Referring to the drawing, weather information may include global light, direct radiance, temperature, humidity, wind speed, dew point, visibility, wind direction, pressure, and the like.

Among them, global radiation, direct radiation, temperature, humidity, wind speed, and the like having a high correlation coefficient may affect a photovoltaic power generation amount.

The server 100 may use information such as global radiance, direct radiance, temperature, humidity, and wind speed among the weather information as main factors to predict photovoltaic power generation.

FIG. 5B is a view illustrating a plurality of prediction models.

Referring to the drawing, a plurality of prediction models may include a general linear model (GLM), artificial neural network (ANN) based on a deep neural network, and Gaussian process (GP).

The general linear model may use global radiance, temperature, and wind speed as input parameters.

Meanwhile, the artificial neural network and the Gaussian process may additionally use humidity as an input parameter, in addition to global radiance, temperature, and wind speed.

As for training and test results according to the three prediction models, a prediction error of the general linear model is 13.3%, a prediction error of the artificial neural network is 11.7%, and a prediction error of the Gaussian process is 9.7 as illustrated.

Accordingly, the processor 170 may use the Gaussian process as a prediction model.

That is, the processor 170 may predict a power generation amount of the solar module 50 by adding time information to the Gaussian process 170. Accordingly, the power generation amount of the solar module 50 may be accurately predicted.

Meanwhile, the processor 170 may generate power generation amount prediction information of the solar module through a plurality of prediction models and predict a power generation amount of the solar module 50 based on a first prediction model which is least different from an actual power generation amount among the plurality of prediction models during a predetermined period. Accordingly, the power generation amount of the solar module 50 may be accurately predicted.

Meanwhile, if power generation amount prediction information of a second prediction model is least different from the actual power generation amount compared with the first prediction model, the processor 170 may change a prediction mode from the first prediction model to the second prediction model and predict a power generation amount of the solar module 50 based on the second prediction model. Accordingly, the power generation amount of the solar module 50 may be accurately predicted.

For example, the Gaussian processor, which is a first prediction model, may be used for 1 month because a prediction error of the Gaussian process is low for 7 days, and a prediction error may be measured for 7 days thereafter.

Here, when a prediction error is measured at the lowest in the artificial neural network, the processor 170 may change the prediction model from the Gaussian process as the first prediction model to the artificial neural network as a second prediction model. Accordingly, the power generation amount of the solar module 50 may be accurately predicted.

Meanwhile, the processor 170 may update the plurality of prediction models. Accordingly, the power generation amount of the solar module 50 may be accurately predicted.

Meanwhile, when comparing the predicted power generation amount of the solar module 500 with an actual power generation amount, the processor 170 may compare a difference during a predetermined period, rather than a temporary difference comparison.

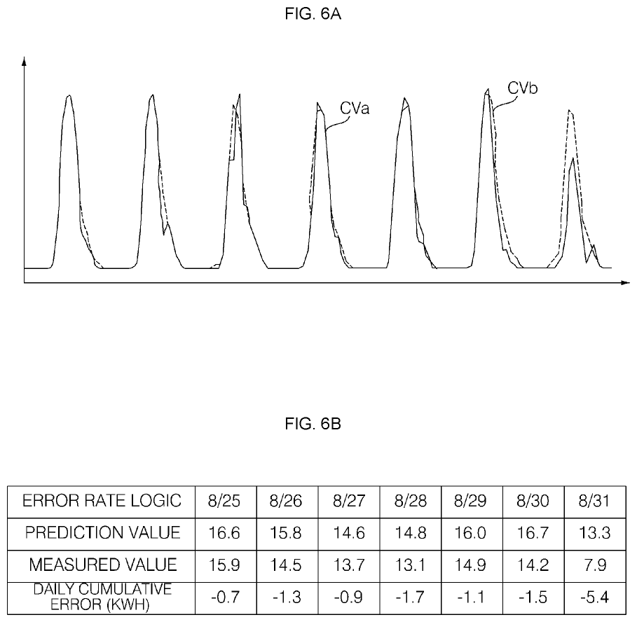

FIG. 6A is a view illustrating a power generation amount prediction curve Cva and an actual power generation amount curve Cvb of the solar module 50 for 7 days.

FIG. 6B is a diagram illustrating daily accumulation of a cumulative error between a predicted power generation amount and a measured value of the solar module 50.

As described above, by accumulating the differences, while comparing the differences over a period of time, the processor 170 may efficiently diagnose the solar module 50 based on the cumulative differences.

For example, when the cumulative difference is greater than or equal to a predetermined value, the processor 170 may control to generate and output abnormality information of the solar module 50. Accordingly, whether the solar module 50 is abnormal may be checked.

In particular, whether some of the cells of the solar module 50 are defective, whether there are shades in some cells, whether contaminants are attached to some cells, or whether a circuit element of the power conversion device is abnormal may be checked.

Meanwhile, when power prediction is accurately performed in the processor 170, the processor 170 may control to perform load balancing of a load connected to the solar module 50.

Here, the load may be a terminal such as a laptop 60a, a mobile terminal 60b illustrated in FIGS. 1A to 1C, a video display device such as a TV, or a home appliance such as a refrigerator, a washing machine, an air conditioner, or the like.

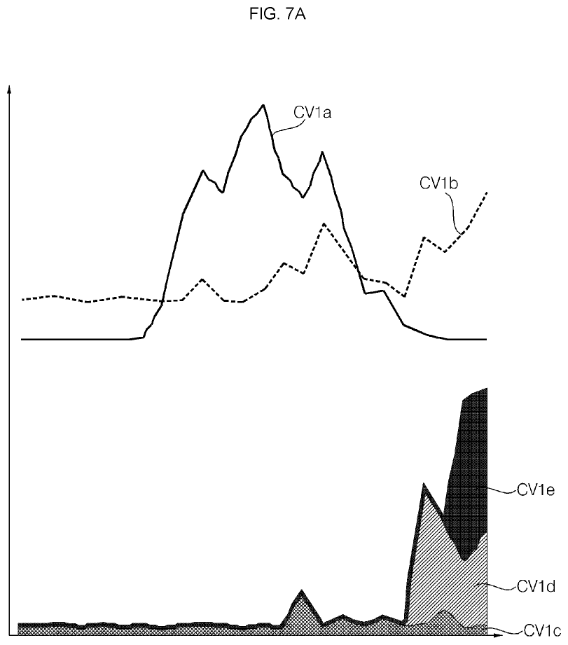

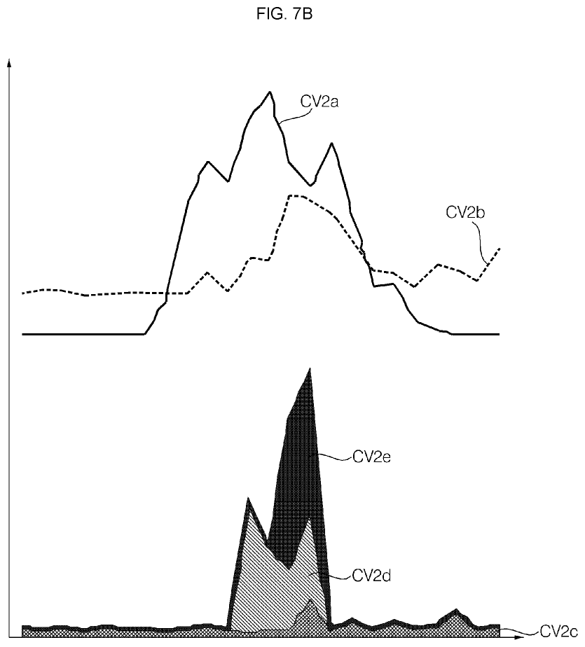

FIG. 7A illustrates a graph before performing load balancing and FIG. 7B illustrates a graph when performing load balancing.

First, in FIG. 7A, CV1a illustrates a graph for predicting a power generation amount of the solar module 50 and CV1b illustrates a load power amount.

In addition, in FIG. 7A, CV1c illustrates power consumption of a refrigerator, CV1d illustrates power consumption of a washing machine, and CV1e illustrates power consumption of a dryer.

A section in which a load power amount is greater than a power generation amount of the solar module 50 because load balancing is not performed occurs.

In FIG. 7B, CV2a illustrates a graph for predicting a power generation amount of the solar module 50 and CV2b illustrates a load power amount.

In addition, in FIG. 7B, CV2c illustrates power consumption of the refrigerator, CV2d illustrates power consumption of the washing machine, and CV2e illustrates power consumption of the dryer.

In particular, by moving operation sections of the washing machine and the dryer according to load balancing, as compared to FIG. 7A, the power generation amount of the solar module 50 may be used as much as possible. Therefore, energy consumption may be efficiently performed.

Meanwhile, the server 100 may receive power consumption information of each electronic device of the load, and total power consumption information may be calculated by adding up the power consumption information.

In addition, the server 100 may output a control signal for changing an operation time for some of the electronic devices of the load by using the total power consumption information and the power generation amount prediction information of the solar module 50.

That is, as shown in FIG. 7B, the server 100 may directly output control signals to advance the operation sections of the washing machine and the dryer to the washing machine and the dryer, respectively, may output the control signals through the gateway 80, or may output the control signals via a mobile terminal or the like. Accordingly, load balancing is performed.

The server according to an embodiment of the present disclosure server includes: a communicator to receive data from an external network or to transmit data to the external network; and a processor to receive power generation information of a solar module and weather information through the communicator and to predict a power generation amount of the solar module based on the power generation information of the solar cell module and the weather information, wherein the processor predicts the power generation amount of the solar module by adding time information to a prediction model. Accordingly, a power generation amount of the solar module may be accurately predicted.

Meanwhile, the processor may perform learning based on the prediction model and predict the power generation amount of the solar module as a result of the learning. Accordingly, a power generation amount of the solar module may be accurately predicted.

Meanwhile, the processor may update the prediction model. Accordingly, a power generation amount of the solar module may be accurately predicted.

Meanwhile, the processor may predict the power generation amount of the solar module during a first period. Accordingly, a power generation amount of the solar module may be accurately predicted.

Meanwhile, the processor may control the first period to increase as accuracy of the weather information increases. Accordingly, a period for predicting a power generation amount of the solar module may be increased.

Meanwhile, the prediction model may include a Gaussian process. Accordingly, a power generation amount of the solar module may be accurately predicted.

Meanwhile, the processor may predict a power generation amount of the solar module by adding time information to the Gaussian process. Accordingly, the power generation amount of the solar module may be accurately predicted.

Meanwhile, the server may further include a memory to store power generation amount prediction information of the solar module. Accordingly, it may be compared with an actual power generation amount.

Meanwhile, the processor may control to generate and output abnormality information of the solar module if a difference between the power generation amount prediction information of the solar module and an actual power generation amount of the solar module is greater than or equal to a predetermined value. Accordingly, whether the solar module is abnormal may be checked.

Meanwhile, the processor may predict a power generation amount for each of a plurality of solar modules and control to perform power generation amount balancing of the plurality of solar modules based on a plurality of power generation amount prediction information. Accordingly, it is possible to balance the power generation amounts in the plurality of solar modules.

Meanwhile, the processor may predict a power generation amount for each of the plurality of solar modules, and if a difference between power generation amount prediction information of a first solar module and power generation amount prediction information of a second solar module, among the plurality of solar modules, is equal to or greater than a reference value, the processor may output a control signal for lowering a power generation amount of the second solar module predicted to have a greater power generation amount. Accordingly, it is possible to balance the power generation amounts in the plurality of solar modules.

Meanwhile, the processor may control to output power generation amount prediction information of the solar module. Accordingly, load balancing of a load connected to the solar module may be performed.

Meanwhile, the processor may generate power generation amount prediction information of a plurality of solar modules through a plurality of prediction models and predict a power generation amount of the solar module based on a first prediction model which is least different from an actual power generation amount among the plurality of prediction models during a predetermined period. Accordingly, the power generation amount of the solar module may be accurately predicted.

Meanwhile, if power generation amount prediction information of a second prediction model is least different from the actual power generation amount compared with the first prediction model, the processor may change a prediction model from the first prediction model to the second prediction model and predict a power generation amount of the solar module based on the second prediction model. Accordingly, the power generation amount of the solar module may be accurately predicted.

Meanwhile, the processor may update the plurality of prediction models. Accordingly, the power generation amount of the solar module may be accurately predicted.

A server according to another embodiment of the present disclosure includes a communicator to receive data from an external network or to transmit data to the external network; and a processor to receive power generation information of a solar module and weather information through the communicator and to predict a power generation amount of the solar module based on the power generation information of the solar cell module and the weather information, wherein the processor predicts the power generation amount of the solar module based on a Gaussian process. Accordingly, the power generation amount of the solar module may be accurately predicted.

Meanwhile, the processor may perform learning based on the Gaussian process and predict a power generation amount of the solar module as a result of the learning. Accordingly, the power generation amount of the solar module may be accurately predicted.

Meanwhile, the server may further include a memory to store power generation amount prediction information of the solar module. Accordingly, it may be compared with an actual power generation amount.

Meanwhile, the processor may control to generate and output abnormality information of the solar module if a difference between the power generation amount prediction information of the solar module and an actual power generation amount of the solar module is greater than or equal to a predetermined value. Accordingly, whether the solar module is abnormal may be checked.

Meanwhile, the processor may predict a power generation amount for each of a plurality of solar modules and control to perform power generation amount balancing of the plurality of solar modules based on a plurality of power generation amount prediction information. Accordingly, it is possible to balance the power generation amounts in the plurality of solar modules.

With the server described above, the configuration of the embodiments described above is not limited in its application, but all or some of the embodiments may be selectively combined to be configured to make various modifications.

Specific embodiments have been described but the present disclosure is not limited to the specific embodiments and various modifications may be made without departing from the scope of the present invention claimed in the claims, and such modifications should not be individually understood from technical concepts or prospects of the present disclosure.

What is claimed is:

1. A server comprising:
a communicator to receive data from an external network or to transmit data to the external network; and
a processor to receive power generation information of a solar module and weather information through the communicator and to predict a power generation amount of the solar module based on the power generation information of the solar cell module and the weather information,
wherein the processor predicts the power generation amount of the solar module by adding time information to a prediction model.

2. The server of claim 1, wherein the processor performs learning based on the prediction model and predicts the power generation amount of the solar module as a result of the learning.

3. The server of claim 1, wherein the processor is configured to update the prediction model.

4. The server of claim 1, wherein the processor predicts the power generation amount of the solar module during a first period.

5. The server of claim 4, wherein the processor controls the first period to increase as accuracy of the weather information increases.

6. The server of claim 1, wherein the prediction model includes a Gaussian process, and the processor predicts the power generation amount of the solar module by adding time information to the Gaussian process.

7. The server of claim 1, further comprising:
a memory to store power generation amount prediction information of the solar module,
wherein the processor controls to generate and output abnormality information of the solar module if a difference between the power generation amount prediction information of the solar module and an actual power generation amount of the solar module is greater than or equal to a predetermined value.

8. The server of claim 1, wherein the processor predicts a power generation amount for each of a plurality of solar modules and control to perform balancing of power generation amounts of the plurality of solar modules based on a plurality of power generation amount prediction information.

9. The server of claim 8, wherein the processor is configured to:
predict a power generation amount for each of the plurality of solar modules, and
if a difference between power generation amount prediction information of a first solar module and power generation amount prediction information of a second solar module, among the plurality of solar modules, is equal to or greater than a reference value, output a control signal for lowering a power generation amount of the second solar module predicted to have a greater power generation amount.

10. The server of claim 1, wherein the processor controls to output power generation amount prediction information of the solar module.

11. The server of claim 1, wherein the processor generates power generation amount prediction information of a plurality of solar modules through a plurality of prediction models and predicts a power generation amount of the solar module based on a first prediction model which is least different from an actual power generation amount among the plurality of prediction models during a predetermined period.

12. The server of claim 11, wherein, if power generation amount prediction information of a second prediction model is least different from the actual power generation amount compared with the first prediction model, the processor changes a prediction model from the first prediction model to the second prediction model and predict a power generation amount of the solar module based on the second prediction model.

13. The server of claim 11, wherein the processor is configured to update the plurality of prediction models.

14. A server comprising:
a communicator to receive data from an external network or to transmit data to the external network; and
a processor to receive power generation information of a solar module and weather information through the communicator and to predict a power generation amount of the solar module based on the power generation information of the solar cell module and the weather information,
wherein the processor predicts the power generation amount of the solar module based on a Gaussian process.

15. The server of claim 14, wherein the processor performs learning based on the Gaussian process and predicts a power generation amount of the solar module as a result of the learning.

16. The server of claim 14, further comprising:
a memory to store power generation amount prediction information of the solar module,
wherein the processor controls to generate and output abnormality information of the solar module if a difference between the power generation amount prediction information of the solar module and an actual power generation amount of the solar module is greater than or equal to a predetermined value.

17. The server of claim 14, wherein the processor predicts a power generation amount for each of a plurality of solar modules and controls to perform balancing of power generation amounts of the plurality of solar modules based on a plurality of power generation amount prediction information.
